(19) United States
(12) Patent Application Publication
(10) Pub. No.: US 2008/0286419 A1
(43) Pub. Date: Nov. 20, 2008

(54) Method for thermal processing of products under vacuum and packaging obtained by executing said process

(76) Inventor: Pierre Berthe, Kain (BE)

Correspondence Address: KENYON & KENYON LLP, 1500 K STREET N.W., SUITE 700, WASHINGTON, DC, 20005, US

(21) Appl. No.: 12/153,149

(22) Filed: May 14, 2008

(30) Foreign Application Priority Data
May 14, 2007 (FR) 0755057

(51) Int. Cl. A23L 1/00; A23L 3/10; A23L 1/01; F24J 3/00; B65D 81/34; B65D 85/00

(52) U.S. Cl. 426/106; 426/403; 432/9; 206/525

(57) ABSTRACT

The invention relates to a method for thermal processing of products contained in a container (2) and a bag obtained by executing said process. According to the invention, the method consists of:
a) forming during a thermoforming step at least one boss in the inner zone of the protective film delimited by the peripheral zone for fixing the film to an edge of the container,
b) boring a degassing orifice in the inner zone of the film,
c) placing the valve on the film above the degassing orifice,
d) fixing the peripheral zone of the film to the edge of the container, previously filled with products,
e) subjecting the container now filled and closed container to thermal processing, during which the valve opens when the temperature of the products reaches a first given value, allowing degassing of the products, and on completion of which the valve closes when the temperature of the products reaches a second given value.

The shapes and dimensions of the boss are determined as a function of the products and thermal processing resulting in the container deforming essentially at the level of said boss after cooling.

The present invention relates to a method for thermal processing of products under vacuum. It also relates to a bag obtained by executing said process.

This method will be adapted in particular for thermal processing of food products, however, the method could also be used to form containers in fields other than that of food cooking and especially in the sterilisation of one-off products in medicine or even in the packaging of pharmaceutical, medicinal or cosmetic preparations.

Containers adapted for cooking under vacuum and permitting food tastes to be preserved have already been made available commercially.

In general, for cooking, the container is associated with a protective film to seal the container, this film being fitted with a valve for degassing the products during thermal processing.

The applicant has observed that given pressure stresses when under vacuum deformations were evident in the container itself, making it difficult to sell the product.

Given this restriction on the container, manufacturers attempted to remedy this disadvantage by reinforcing the container or even by modifying the vacuum conditions during cooking, but these solutions prove dissatisfactory and in any case it seems that they are not adapted to cooking in particular in a microwave.

The aim of the present invention is to rectify the above disadvantages and propose a method for thermal processing of products and especially cooking agri-food products, the method enabling application of extended cooking structures with considerable vacuums.

Another advantage of the present invention is to propose a method for thermal processing of products, especially cooking of food products allowing deformation of the container to be limited and also preventing foodstuffs from being crushed.

Another object of the present invention is to propose a method for thermal processing of products, especially cooking of food products in which products having low resistance and especially products which are crumbly could be placed in containers.

Another advantage of the present invention is to propose a method for thermal processing of products, especially cooking food products in which the cooking can be performed in a microwave oven.

Documents WO-02/066336 and WO-2006/109000 are known to resolve some of the above disadvantages.

According to document WO-02/066336, means are provided for controlling deformation of a flexible wall of a receptacle during cooling and after the sealing operation. To achieve this result, particular temperature and pressure curves need to be followed and injection of an additional gaseous fluid into the receptacle during cooling also needs to be undertaken. Also, deformation of the wall of the receptacle prior to sealing, especially imparting localised concavity, allows some overpressure to be maintained in said receptacle before closing, and also allows the fact to be considered that a certain volume of gaseous fluid will be produced by the material contained inside said receptacle, after closing of the escape orifice. Consequently, instead of the shape of the receptacle being altered, the volume of fluid will on the contrary allow the receptacle to regain a suitable shape.

Document WO-2006/109000 also provides a method for processing a product contained in packaging such as a container. According to this document, a step is provided in which a gaseous fluid is introduced into the bag to cause an increase in its internal volume by provisional deformation of its deformable wall, and cause overpressure. The bag can then be closed, and then when the content inside this bag has regained its normal volume at room temperature the bag will have regained a shape close to its initial shape without excessive deformation.

According to document WO02/066336 injection of the additional gaseous fluid allowing deformation of the wall is done during thermal processing and especially throughout the cooling phase. Similarly, in document WO-2006/109000 a volume of gas is introduced on completion of the temperature maintenance step. Consequently, according to these two documents, the container-sealing step is done during thermal processing, said thermal processing being consequently done on non-sealed packaging. Also, these processes do not completely control deformation of the protective film.

The aim of the invention is also to rectify the disadvantages of the processes and bag described in documents WO-02/066336 and WO-2006/109000.

The aim of the invention is a method for thermal processing of products, especially the cooking of food products contained in a container closed by a protective film and fitted with a valve for degassing the products during said thermal processing.

According to the invention the method consists of:

a) forming during a thermoforming step, at least one boss in the inner zone of the protective film delimited by the peripheral zone for fixing the film to the edge of the container,

b) boring a degassing orifice in the inner zone of the film,

c) placing the valve on the film above the degassing orifice,

d) fixing the peripheral zone of the film to the edge of the container previously filled with products,

e) subjecting the now filled and closed container to thermal processing during which the valve opens when the temperature of the products reaches a first given value allowing degassing of the products and on completion of which the valve closes when the temperature of the products reaches a second given value, the shapes and dimensions of the boss of the protective film being determined as a function of the products and thermal processing resulting, after cooling, in the container deforming essentially at the level of said boss.

The aim of the invention is also a bag containing the thermally processed product obtained by carrying out the method according to the above characteristics.

Other characteristics and advantages of the invention will emerge more clearly from the following description of a preferred embodiment in which the description is given only by way of non-limiting example and in reference to the attached diagrams, in which:

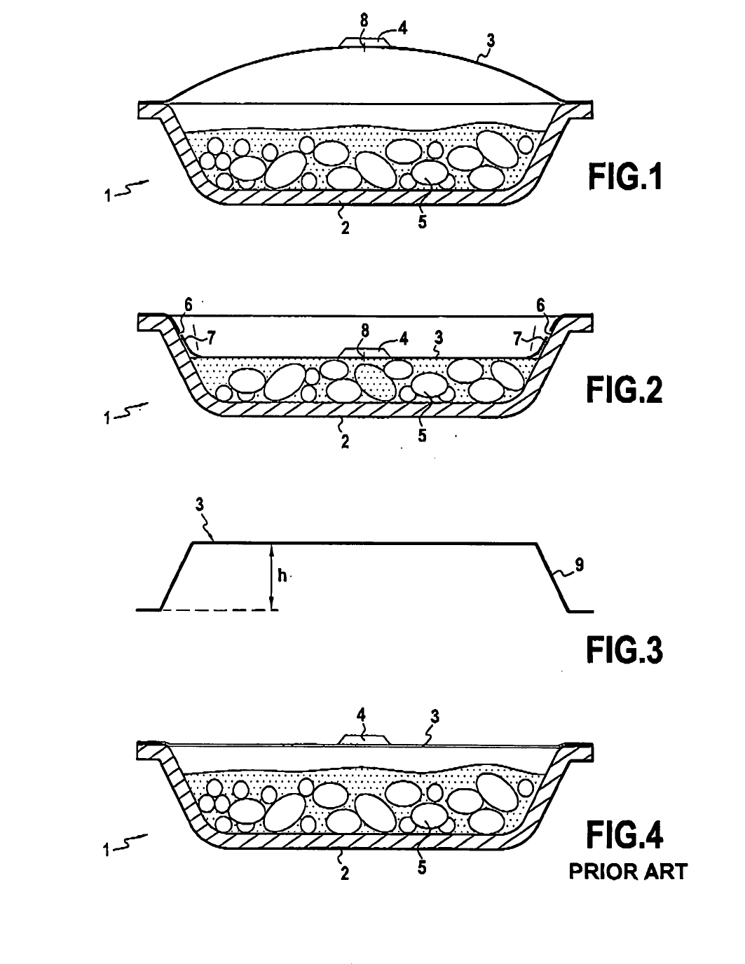

FIG. 1 illustrates in schematic section a bag with a container closed by a protective film in a step carrying out the process,

FIG. 2 illustrates closed a closed bag, such as shown in FIG. 1 in the final step of the process,

FIG. 3 illustrates an example of deformation profile of the protective film according to a step of the process,

FIG. 4 illustrates an embodiment of a bag according to the prior art.

With reference to FIG. 1, this shows a bag 1 composed of a container 2, a protective film 3 and a valve 4.

Products 5 are placed inside the container 2. In the example of FIGS. 1 and 2 these are food products.

It is evident that contrary to the prior art illustrated in FIG. 4 the protective film 3 is not placed flat on the container 2 during the thermo-sealing operation, but does have a boss 9.

In the example of FIG. 1 this boss 9 is a positive boss 9 extending above the container 2.

However, it could also be that this boss 9 is a negative boss 9, that is, it will protrude partly inside the container 2 relative to the sealing surface.

Deformation of the protective film 3 is done just before the sealing operation of the film 3 on the edges of the container 2.

By way of advantage, forming of the boss 9 is done by a thermoforming operation.

During the cooling phase this boss 9 prevents any deformation of the container 2, deformation, which is actually due to the vacuum formed during this cooling phase, being prevented by deformation of the protective film 3, is such as shown in FIG. 2.

Contrary to the prior art illustrated in FIG. 4, deformation of the boss 9 consequently results in a finished product in which the container 2 is not deformed. In this respect, FIG. 4 illustrates a bag 1 obtained by classic techniques in which it is evident that the protective film 3 cannot deform, being positioned flat, and in which the walls of the container 2 deform after stresses generated during cooling, causing a vacuum inside the container 2.

Advantageously, a particular deformation profile of the protective film 3 is provided so as to limit stresses on this film 3 when it is in the position illustrated in FIG. 2, that is, after the cooling step.

To this end, according to a preferred embodiment, the deformation profile of the protective film 3 corresponds to the shape of the inner walls 6 of the container 2 for limiting tension on the film during and after the vacuum step.

Deformation of the film 3 is advantageously accentuated in the direction of the edges to limit tension of the film 3 in the lateral zones 7, especially given shrinkage occurring during the cooling and vacuum step.

In this respect, a possible deformation profile of the protective film 3 is shown in FIG. 3.

In this figure, it is evident that the boss has a maximum depth h. Advantageously, this depth h of the positive or negative boss is determined as a function of the supplementary volume to be obtained relative to the free volume of the container after vacuum.

Free volume of the container after vacuum is understood to mean the free space between the sealing plane and the products 5 to be processed in the container 2 once the products 5 are placed under vacuum.

By way of advantage, it is provided that deformation of the protective film corresponds to the free volume of the container 2 after placing under vacuum more or less 15 %.

With respect to placement of the degassing orifice 8, the latter could be placed substantially in the centre of the film 3, such as shown in FIGS. 1 and 2, or even placed near an edge of the container 2.

Once the shaping operation of the boss 9 is completed, the operations of boring the degassing orifice 8 in the inner zone of the film, then placement of the valve 4 on the film 3 above the degassing orifice 8, then a step for fixing the peripheral zone of the film 3 to the edge of the container 2 previously filled with products are carried out.

The method then consists of subjecting the filled and closed container to thermal processing during which the valve 4 opens when the temperature of the products reaches a first given value for degassing the products and on completion of which the valve 4 closes when the temperature of the products reaches a second given value.

Given the shape and dimensions of the boss 9 of the protective film 3 and such as shown in FIG. 2, it is evident that on completion of the different steps of the method the container 2 has not deformed and consequently the bag 1 maintains very good appearance.

It is also important to stress at this point that cooking of the products 5 could be done continuously in a microwave oven.

This being the case, thermal processing could also be done according to other conventional cooking modes in the field.

Of course, other embodiments familiar to the expert could also be feasible, without as such departing from the scope of the invention as defined by the following claims.

1. A method for thermal processing of products, especially cooking of food products, contained in a container closed by a protective film and fitted with a valve for degassing the products during said thermal processing, said method comprising:
a) forming during a thermoforming step at least one boss in the inner zone of the protective film delimited by the peripheral zone for fixing the film to an edge of the container,
b) boring a degassing orifice in the inner zone of the film,
c) placing the valve on the film above the degassing orifice
d) fixing the peripheral zone of the film to the edge of the container, previously filled with products,
e) subjecting the now filled and closed container to thermal processing, during which the valve opens when the temperature of the products reaches a first given value, allowing degassing of the products, and on completion of which the valve closes when the temperature of the products reaches a second given value,
the shapes and dimension of said boss of the protective film being determined as a function of the products and thermal processing resulting in the container deforming essentially at the level of said boss after cooling.

2. The method according to claim 1, wherein the volume generated by deformation of the protective film corresponds to the free volume of the container after placing under vacuum more or less 15%.

3. The method according to claim 1, wherein deformation of the film is accentuated in the direction of the edges.

4. The method according to claim 1, wherein the deformation profile of the protective film corresponds to the shape of the inner walls of the container to limit tension on the film during and after the vacuum step.

5. The method according to claim 1, wherein the degassing orifice is placed substantially in the center of the film.

6. The method according to claim 1, wherein the degassing orifice is placed near an edge of the container.

7. The method according to claim 1, wherein the thermal processing step is carried out continuously in a microwave oven.

8. Packaging containing a thermally processed product obtained by executing the method according to claim 1.
